(19) United States
(12) Patent Application Publication
(10) Pub. No.: US 2020/0028350 A1
(43) Pub. Date: Jan. 23, 2020

(54) DC OVERVOLTAGE PROTECTION FOR AN ENERGY SYSTEM

(71) Applicant: SIEMENS AKTIENGESELLSCHAFT, München (DE)

(72) Inventors: Peter ECKERT, Erlangen (DE); Daniel LANGBEIN, Roettenbach (DE); Johannes REINSCHKE, Nuernberg (DE)

(73) Assignee: Siemens Aktiengesellschaft, München (DE)

(21) Appl. No.: 16/335,808

(22) PCT Filed: Sep. 5, 2017
(86) PCT No.: PCT/EP2017/072143

§ 371 Date: Mar. 22, 2019

(30) Foreign Application Priority Data
Sep. 22, 2016 (DE) 10 2016 218 242.0

(51) Int. Cl. H02H 7/00

(52) U.S. Cl. CPC H02H 7/00

(57) ABSTRACT

A DC overvoltage protection device for an energy storage system and/or an energy generating system has at least one auxiliary release on an AC-switch and the at least one auxiliary release interrupts the AC switch. The DC overvoltage protection device further has at least one electrical energy store and/or at least one photovoltaic installation and a plurality of converters each having a power section having a DC voltage measurement system and an interface.

The invention relates to a DC overvoltage protection apparatus for an energy storage system and/or energy generation system, to an energy storage system and/or energy generation system having such a DC overvoltage protection apparatus, to a method for operating a DC overvoltage protection apparatus for an energy storage system and/or energy generation system and to a method for operating an energy storage system and/or energy generation system with a DC overvoltage protection apparatus.

In particular electrical energy storage systems having a plurality of converters, so-called AC-DC transducers, are known. One or more batteries are connected to each converter of such an energy storage system. If the converters are connected on the AC side, that is to say on the alternating current side, to a common busbar and if there is no direct DC-side coupling, that is to say on the direct-current side, then in the case of the parallel connection of a plurality of converters on a common AC busbar, an undesired disconnection of the battery or batteries connected to the intermediate circuit and simultaneous pulse inhibition of the respectively associated converter, uncontrolled charging of the converter intermediate circuit can occur. An analogous problem also results in energy systems having one or more converters for photovoltaic installations, so-called PV installations, that is to say energy generators or energy generation systems. In such a case of uncontrolled charging of the converter intermediate circuit, the opening of an AC contactor associated with the converter or converters can be effected by means of an implemented software solution.

Since the software-based opening of the AC contactor does not always take place in a timely manner, the object of the invention consists in providing a reliable and fast alternative for the software-implemented release of the opening of the AC contactor that has a lower degree of complexity and is also more cost-effective.

This object is achieved by way of the features of independent claim 1 and the claims dependent thereon.

In particular, the object is realized by an electrical coupling of the DC voltage measurement system, and the associated generation of a fault signal in the case of a DC overvoltage in the driver of the power section, with one or more auxiliary releases, that is to say at least one auxiliary release, of the AC switch of the converter. The fault signal is configured here in such a way that the fault signal is identical to the control signal for the AC switch. This achieves a situation in which, in addition to the mechanical switch-off time of the AC switch, there are no further delays, in particular processing delays and/or switching delays. In the following text, an AC switch is to be understood to mean an AC circuit breaker. The at least one auxiliary release of the AC switch is preferably an operating current release, a switch-on release and/or an undervoltage release. One or more auxiliary releases are each associated with an AC switch and a converter and are connected and/or can be connected thereto. In the following text, an auxiliary release is thus to be understood to mean at least one auxiliary release, that is to say one or more, in particular two or three, auxiliary releases, wherein the at least one auxiliary release is connected to an AC switch and to at least one output for a digital fault signal of an interface of the at least one converter or the plurality of converters. The auxiliary releases are preferably integrated in the AC switch and form one unit together with the release of the AC switch or the auxiliary releases are preferably identical to the release of the AC switch.

In the case of an electrical energy storage system and/or energy generation system according to the invention, battery stores and stores based on ultracaps or supercaps, or supercapacitors, are preferred.

In particular, the combination with PV installations is also preferred.

In an exemplary embodiment of a DC overvoltage protection apparatus for an energy storage system and/or energy generation system having at least one electrical energy store, a plurality of converters, in particular bidirectional AC-DC transducers, at least one AC switch, preferably an AC switch for each converter, having at least one auxiliary release and at least one AC connection, such as a busbar or a cable or another electrically conductive connection for energy transmission, the DC overvoltage protection is implemented as follows. In the following text, an AC connection should be understood to mean an electrically conductive connection on the AC side.

The converters of the plurality of converters each have a power section having a DC voltage measurement system and an interface, in particular a driver interface, having at least one output for a digital fault signal, wherein the DC overvoltage protection apparatus has at least one auxiliary release, the interface, in particular the driver interface, is connected or can be connected to the DC voltage measurement system in such a way that, in the event of an overvoltage at the DC voltage measurement system, a fault signal is transmitted from the interface, in particular the driver interface, to the at least one output for a digital fault signal, and the at least one auxiliary release is connected or can be connected to the at least one output for a digital fault signal in such a way that the fault signal can be used or is used directly, that is to say without further processing, as an input signal for the at least one auxiliary release of the AC switch, and the at least one auxiliary release of the AC switch is actuated in such a way that either opening of the AC switch, that is to say interruption of the AC switch, is effected or can be effected thereby.

It is also preferred that, in the event of an overvoltage at the DC voltage measurement system at the at least one output for a digital fault signal, the fault signal changes over from a “high” state to a “low” state and opening of the AC switch is thus effected or can be effected. As an alternative, in the event of an overvoltage at the DC voltage measurement system at the at least one output for a digital fault signal, the fault signal can change over from a “low” state to a “high” state and opening of the AC switch is thus effected or can be effected thereby.

It is also preferred that, in a first operating state of the DC overvoltage protection apparatus in which the DC voltage measurement system does not produce an overvoltage, owing to the “high” state at the at least one output for a digital fault signal, which is connected or can be connected to the input of the solid-state relay, the at least one auxiliary release is kept in the closed state and the transition at the at least one output for a digital fault signal, which output is connected or can be connected to the input of the at least one auxiliary release, into the “low” state effects a second operating state in which the AC switch is open, or, in a first operating state of the DC overvoltage protection apparatus in which the DC voltage measurement system does not produce an overvoltage, owing to the “low” state at the at least one output for a digital fault signal, which output is connected or can be connected to the input of the at least one auxiliary release, the at least one auxiliary release is kept in a closed state and the transition at the at least one output for a digital fault signal, which is connected or can be connected to the input of the at least one auxiliary release, into the “high” state effects a second operating state in which the at least one auxiliary release is open.

It is furthermore preferred that the at least one auxiliary release has a reaction time of less than or equal to 1 ms, preferably of less than 1 ms.

It is also preferred that the at least one AC switch has an opening time of less than 60 ms and preferably of less than 50 ms.

It is furthermore preferred that the at least one auxiliary release is operated or can be operated at preferably 24 V DC/AC with a power draw of 250 W to 350 W, preferably 300 W, and/or 24 V DC/AC and with a power draw of 2.5 W to 4.0 W, preferably 3.5 W.

Also preferred is an energy storage system and/or an energy generation system having at least one electrical energy store, a plurality of converters, in particular bidirectional AC-DC transducers, wherein the converters of the plurality of converters each have a power section having a DC voltage measurement system and an interface, in particular a driver interface, having at least one output for a digital fault signal, at least one AC switch having at least one auxiliary release, at least one AC connection, and a DC overvoltage protection apparatus, as described in one or more preceding embodiments.

Also preferred is a method for operating a DC overvoltage protection apparatus for an energy storage system and/or energy generation system as per one of the preceding embodiments, wherein a fault signal from the at least one output for a digital fault signal at the DC voltage measurement system is used as an input signal of the at least one auxiliary release, and in that, in the event of an overvoltage at the DC overvoltage measurement system, the fault signal effects or can effect either switching of the AC switch to an interrupted switching state and/or closed switching state of the AC switch.

It is furthermore preferred that the method for operating an energy storage system and/or energy generation system having a DC overvoltage protection apparatus as per the preceding embodiments is provided, wherein a fault signal from the at least one output for a digital fault signal at the DC voltage measurement system is used as an input signal of the at least one auxiliary release, and in that, in the event of an overvoltage at the DC voltage measurement system, the fault signal effects or can effect opening of the AC switch to an interrupted switching state of the AC switch.

In the following text, the subject matter of the invention is explained in more detail on the basis of two figures:

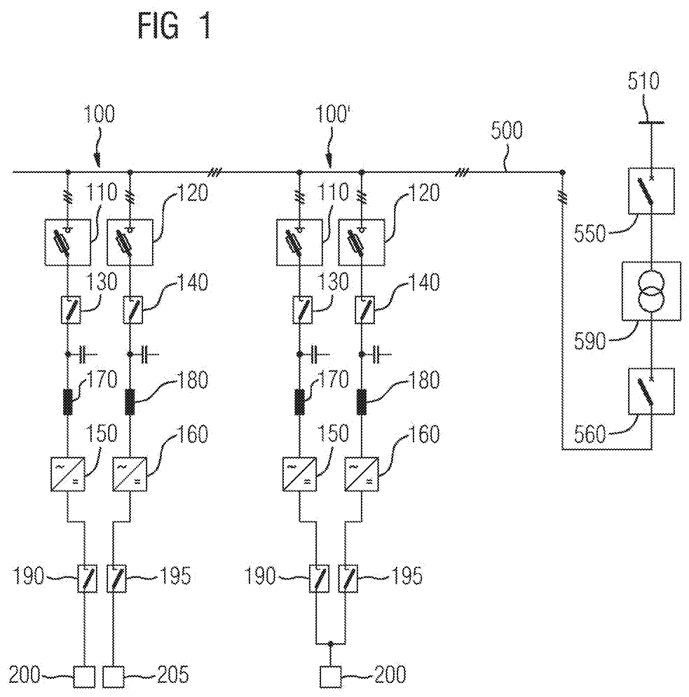

FIG. 1: shows two variants for energy storage systems having converters;

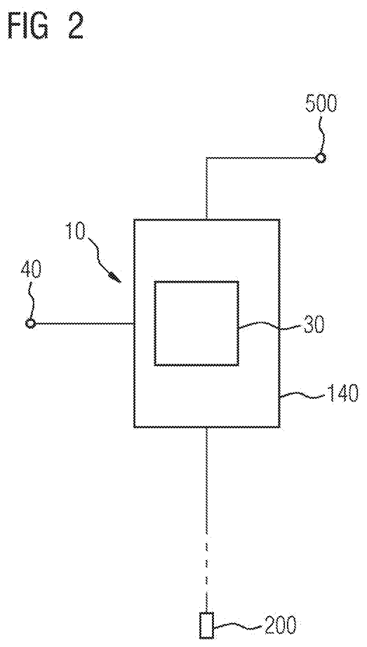

FIG. 2: shows a schematic illustration of a DC overvoltage protection apparatus.

FIG. 1 shows two examples for variants 100, 100′ of how battery stores 200, 205 and converters 150, 160 can be connected to a network terminal connection 510 by means of a common AC connection, in this case a busbar 500. The first and second variant 100 and 100′ in this case each have AC switches 130, 140.

The AC busbar 500 is preferably connected to the network terminal connection via a transformer 590, wherein a respective switch 550, 560, particularly preferably a circuit breaker or contactor, is preferably present behind and in front of the transformer.

In the first variant 100, by way of example two strands branch off from the AC busbar 500, said strands each being led via a load interrupter 110, 120, an AC switch 130, 140 and an LC filter circuit 170, 180 to a converter 150, 160. The converters 150, 160 are connected to a respective battery store 200, 205 via DC switches 190, 195. The two strands of the first variant 100 are not coupled, or only capacitively, on the DC side, in particular capacitively coupled via the battery stores. Even if only two strands are shown in the first variant 100, said variant is the basic construction, with the result that more than two strands are also possible.

In the second variant 100′, by way of example two strands branch off from the AC busbar 500, said strands each being led via a load interrupter 110, 120, an AC switch/AC contactor 130, 140 and an LC filter circuit 170, 180 to a converter 150, 160. The converters 150, 160 are connected to a battery store 200 via DC switches 190, 195. The two strands of the second variant 100′ are coupled on the DC side, in particular coupled via the battery stores. Even if only two strands are shown in the second variant 100′, said variant is the basic construction, with the result that more than two strands are also possible.

The combination shown here of the variants 100, 100′ is also possible. The two variants 100, 100′ shown can also be combined with other superstructures for connecting the electrical energy stores.

FIG. 2 shows a schematic illustration of a DC overvoltage protection apparatus 10. The input signal 40 for the at least one auxiliary release 30 of the AC switch is transmitted from a DC voltage measurement system having an interface, in particular a driver interface, to the at least one auxiliary release 30. The input signal 40 may be, for example, a “high” signal, which serves as an operating current release for releasing the at least one auxiliary release 30 for the AC switch 140, or else a “low” signal, which serves as an undervoltage release for releasing the at least one auxiliary release 30 for the AC switch 140. The AC switch 140 interrupts the indicated connection between the AC busbar 500 and the electrical energy store 200.

### LIST OF REFERENCE SIGNS

10 DC overvoltage protection
30 Auxiliary release or at least one auxiliary release of an AC switch
40 Input signal for the at least one auxiliary release
100 First variant of an energy store with converter
100′ Second variant of an energy store with converter
110, 120 Load interrupter with fusible link
130, 140 AC switch
150, 160 Converter
170, 180 LC filter circuit
190, 195 DC switch
200, 205 Electrical energy store
500 AC busbar
510 Network connection terminal
550, 560 AC switch/AC contactor
590 Transformer

1-9. (canceled)

10. A DC overvoltage protection apparatus for an energy storage system or an energy generation system containing at least one electrical energy store and/or at least one photovoltaic installation, a plurality of converters each having a power section with a DC voltage measurement system, an interface and at least one output for a digital fault signal, at least one AC switch, and at least one AC connection, the DC overvoltage protection apparatus comprising:
at least one auxiliary release having an input;
the interface is connected to the DC voltage measurement system in such a way that, in an event of an overvoltage at the DC voltage measurement system, a fault signal is transmitted from the interface to the at least one output for the digital fault signal; and
said at least one auxiliary release is connected to the at least one output for the digital fault signal in such a way that the fault signal is used as an input signal for said at least one auxiliary release, and said at least one auxiliary release is connected to the AC switch in such a way that
switching of the AC switch to an interrupted switching state of the AC switch is effected thereby, or a change in the input signal at said input of said at least one auxiliary release effects switching of the AC switch to an interrupted switching state of the AC switch.

11. The DC overvoltage protection apparatus according to claim 10, wherein:
in an event of the overvoltage at the DC voltage measurement system at the at least one output for the digital fault signal, the fault signal changes over from a “high” state to a “low” state and opening of the AC switch is thus effected by means of said at least one auxiliary release; or
in an event of the overvoltage at the DC voltage measurement system at the at least one output for the digital fault signal, the fault signal changes over from a “low” state to a “high” state and the opening of the AC switch is thus effected by means of said at least one auxiliary release.

12. The DC overvoltage protection apparatus according to claim 11, wherein:
in a first operating state of the DC overvoltage protection apparatus in which the DC voltage measurement system does not produce an overvoltage, owing to the “high” state at the at least one output for the digital fault signal, which is connected to said input of said at least one auxiliary release, said at least one auxiliary release keeps the AC switch in a closed state and a transition at the at least one output for the digital fault signal, the output is connected to said input of said at least one auxiliary release, into the “low” state effects a second operating state in which the AC switch is open; or
in the first operating state of the DC overvoltage protection apparatus in which the DC voltage measurement system does not produce an overvoltage, owing to the “low” state at the at least one output for the digital fault signal, the output is connected to said input of said at least one auxiliary release, said at least one auxiliary release keeps the AC switch in the closed state and the transition at the at least one output for the digital fault signal, which is connected to said input of said at least one auxiliary release, into the “high” state effects a second operating state in which the AC switch is open.

13. The DC overvoltage protection apparatus according to claim 10, wherein said at least one auxiliary release has a reaction time of less than or equal to 1 ms.

14. The DC overvoltage protection apparatus according to claim 10, wherein the at least one AC switch has an opening time of less than 60 ms.

15. The DC overvoltage protection apparatus according to claim 10, wherein said at least one auxiliary release is operated at 24 V DC/AC with a power draw of 250 W to 350 W.

16. The DC overvoltage protection apparatus according to claim 10, wherein:
the converters are bidirectional AC-DC transducers;
the interface is a driver interface; and
the at least one AC switch is one of a plurality of AC switches, and one of the AC switches is connected to each of the converters.

17. The DC overvoltage protection apparatus according to claim 10, wherein said at least one auxiliary release has a reaction time of less than 1 ms.

18. The DC overvoltage protection apparatus according to claim 10, wherein the at least one AC switch has an opening time of less than 50 ms.

19. The DC overvoltage protection apparatus according to claim 10, wherein said at least one auxiliary release is operated at 24 V DC/AC with a power draw of 2.5 W to 4 W.

20. An energy storage system and/or energy generation system, comprising:
at least one electrical energy store and/or at least one photovoltaic installation;
a plurality of converters, said converters each having a power section with a DC voltage measurement system, an interface, and at least one output for a digital fault signal;
at least one AC switch;
at least one AC connection;
a DC overvoltage protection apparatus having at least one auxiliary release with an input;
said interface is connected to said DC voltage measurement system in such a way that, in an event of an overvoltage at said DC voltage measurement system, a fault signal is transmitted from said interface to said at least one output for the digital fault signal; and
said at least one auxiliary release is connected to said at least one output for the digital fault signal in such a way that the fault signal is used as an input signal for said at least one auxiliary release, and said at least one auxiliary release is connected to said AC switch in such a way that switching of said AC switch to an interrupted switching state of said AC switch is effected thereby, or a change in the input signal at said input of said at least one auxiliary release effects switching of said AC switch to an interrupted switching state of said AC switch.

21. A method for operating a DC overvoltage protection apparatus for an energy storage system and/or energy generation system, which comprises the steps of:
using a fault signal from at least one output for a digital fault signal at a DC voltage measurement system as an input signal of at least one auxiliary release, and in that, in a event of an overvoltage, the fault signal effects an opening of an AC switch and hence switching of the AC switch to an interrupted switching state of the AC switch.

22. A method for operating an energy storage system and/or energy generation system, which comprises the step of:
using a fault signal from at least one output for a digital fault signal of a DC voltage measurement system as an input signal of at least one auxiliary release, and in that, in an event of an overvoltage, the fault signal effects an opening of an AC switch, that is to say switching of the AC switch to an interrupted switching state of the AC switch.
